(19) United States
(12) Patent Application Publication
(10) Pub. No.: US 2015/0301648 A1
(43) Pub. Date: Oct. 22, 2015

(54) INFORMATION PROCESSING DEVICE, CONTROL METHOD, PROGRAM, AND RECORDING MEDIUM

(71) Applicant: PIONEER CORPORATION, Kanagawa (JP)

(72) Inventor: Takahito OGAWA, Kanagawa-ken (JP)

(21) Appl. No.: 14/441,979

(22) PCT Filed: Nov. 15, 2012
(86) PCT No.: PCT/JP2012/079685

§ 371 Date: May 11, 2015

(51) Int. Cl. G06F 3/044; G06F 3/01

(52) U.S. Cl. CPC G06F 3/044; G06F 3/017

(57) ABSTRACT

A terminal device 100 recognizes a swipe operation from a user on a touch panel 120. A control unit 16 reads out information on the resolution from a storage unit 13. Additionally, the control unit 16 sets a threshold value Dth in accordance with a required movement distance Lth by which the swipe operation is determined to be valid. Specifically, the control unit 16 calculates the threshold value Dth by multiplying the required movement distance Lth by the resolution read out from the storage unit 13.

### TECHNICAL FIELD

The present invention relates so a technology for recognizing en input or a touch panel.

### BACKGROUND TECHNIQUE

Conventionally, there are known methods of recognizing a swipe (flick) operation on a touch panel. Generally, the term “swipe” indicates such an operation that a pointer such as a finger and a stylus is slid on a touch panel in contact with the touch panel, and the term “flick” particularly indicates an operation of quickly sweeping the contact point. In either case, the swipe operation or the flick operation is recognized on the basis of the movement amount of the contact point of the finger or the stylus. For example, Patent Reference-1 discloses a technology of changing the movement amount necessary for accepting a flick operation in effect based on information car the pixel numbers of the display in the vertical and the horizontal directions.
Patent Reference-1: Japanese Patent Application Laid-open under No. 2010-128830

### DISCLOSURE OF INVENTION

### Problem to be Solved by the Invention

Generally, resolution indicating the density of pixels essentially differs depending on each terminal device. Thus, even if both of pixel numbers in the vertical and the horizontal directions are the same in two displays, it does not mean that the sizes of the two display are the same. Thus, provided that the movement amount necessary for accepting a swipe operation in effect is determined based on the pixel numbers without considering the resolution as disclosed in Patent Reference-1, a longer distance of the swipe it required for the bigger display when two displays have the satin pixel number and different sizes. In contrast, it could be preferred for user that the distance of the swipe necessary for recognizing the swipe operation in effect is constant regardless of the site of the display.

The present invention has been achieved to solve the above problem. It is an object of this invention to provide an information processing device capable of determining whether or not a swipe operation is performed.

### Means for Solving the Problem

One invention is an information processing device configured to determine whether or not a swipe operation from a user on a touch panel is performed, including: an acquisition unit configured to acquire information on an inherent resolution of the information processing device; and a setting unit configured to set a threshold value corresponding to a movement, distance to be determined that the swipe operation is valid, wherein the setting unit sets the threshold value based on the information on the resolution acquired by the acquisition unit.

Another invention is an information processing device configured to move along with a moving body and to determine whether or not a swipe operation from a user on a touch panel is performed, including: a first acquisition unit configured to acquire information on an inherent resolution of the information processing device; a second acquisition unit configured to acquire information on a running speed of the moving body; and a setting unit configured to set a threshold value corresponding to a movement distance to be determined that the swipe operation is valid, wherein the setting unit determines the movement distance to be determined that the swipe operation is valid based on the information on the running speed while setting the threshold value based on the information on the resolution acquired by the first acquisition unit.

Still another invention is an information processing device configured to determine whether or not a swipe operation from a user on a touch panel is performed, including: an acquisition unit configured to acquire information on an inherent resolution of the information processing device; a pixel number calculation unit configured to calculate a pixel number corresponding to a movement amount of a contact area on the touch panel; a movement distance calculation unit configured to calculate a physical movement distance of the contact area from the pixel number based on the information on the resolution acquired by the acquisition unit; and a determination unit configured to determine that the swipe operation is performed when the movement distance is equal to or larger than a predetermined threshold value.

Still another invention is a control method executed by an information processing device which determines whether or not a swipe operation from a user on a touch panel is performed, including: an acquisition process for acquiring information on an inherent resolution of the information processing device; and a setting process for setting a threshold value corresponding to a movement distance to be determined that the swipe operation is valid, wherein in the setting process, the threshold value is set based on the information on the resolution acquired in the acquisition process.

Still, another invention is a program executed by an information processing device which determines whether or not a swipe operation from a user on a touch panel is performed, making the computer function as: an acquisition unit configured to acquire information on an inherent resolution of the information processing device; and a setting unit configured to set a threshold value corresponding to a movement distance to be determined that the swipe operation is valid, wherein the setting unit sets the threshold value based on the information on the resolution acquired by the acquisition unit.

### BRIEF DESCRIPTION OF THE INVENTION

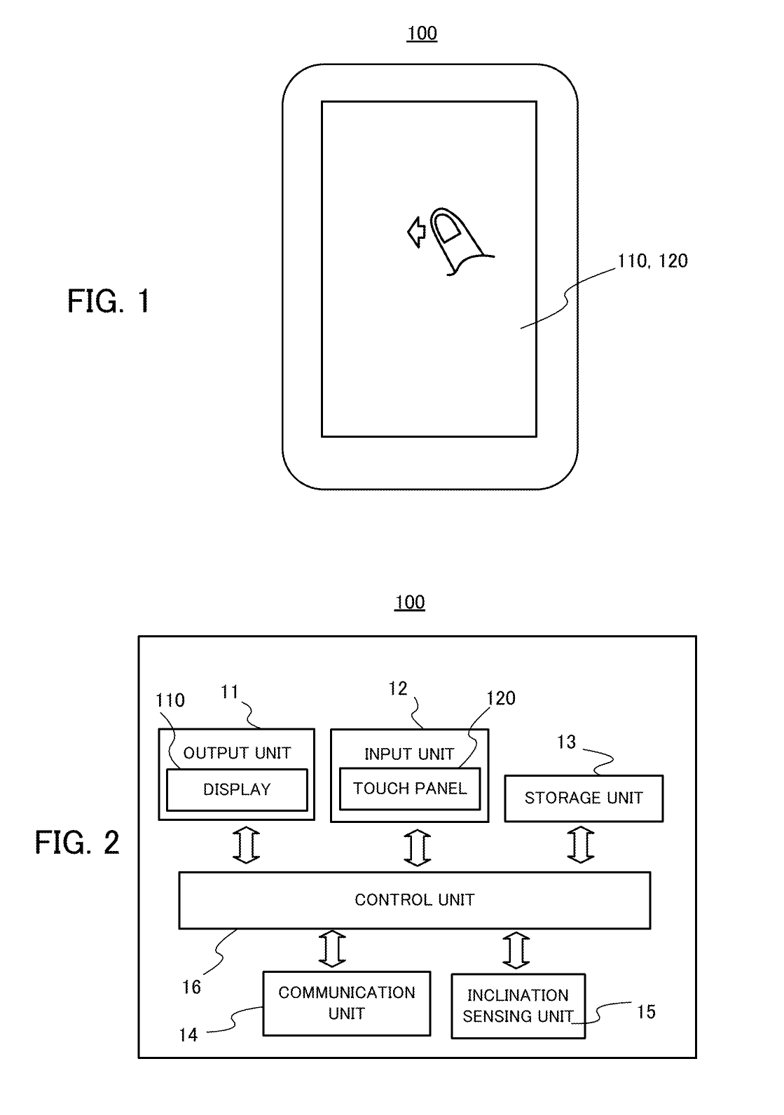

FIG. 1 illustrates a front view of a terminal device.

FIG. 2 illustrates a schematic configuration of the terminal device according to the first embodiment.

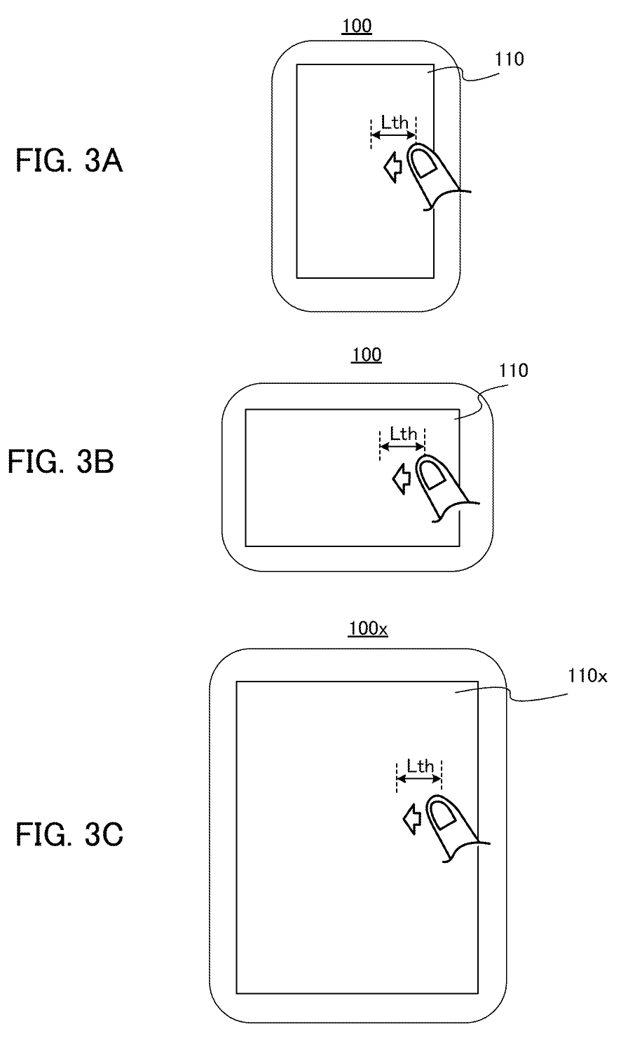

FIGS. 3A to 3C are drawings for explaining a required movement distance.

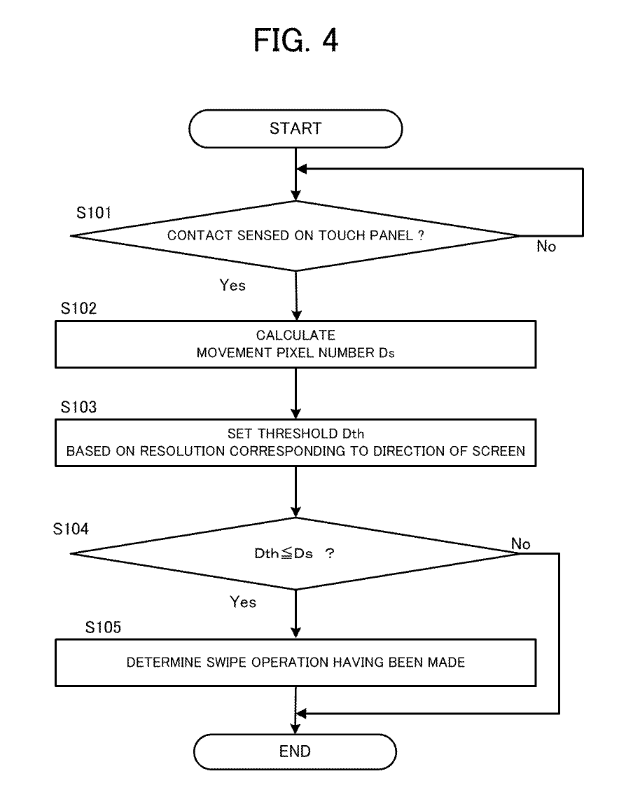

FIG. 4 is an example of a flowchart indicating a determination method regarding the validity of a swipe operation according to the first embodiment.

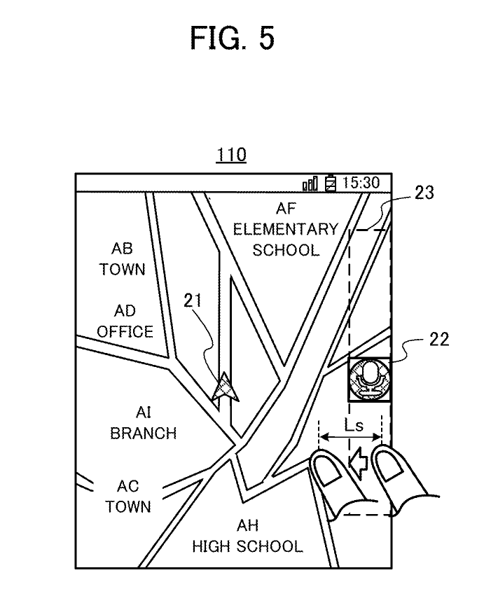

FIG. 5 illustrates a display which displays a map including a present position mark indicating the present position.

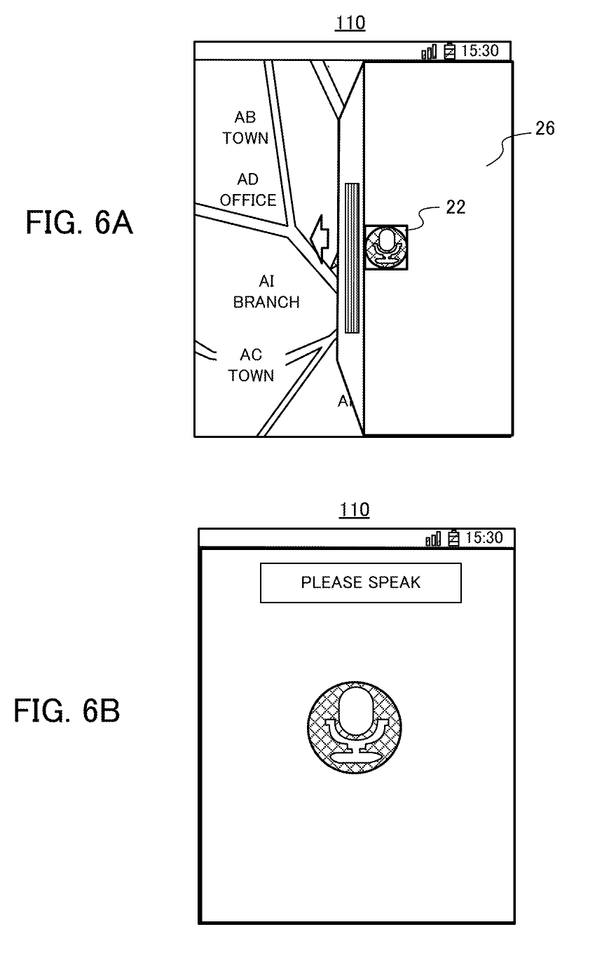

FIGS. 6A and 6B illustrate the screen transition of the display in a case that a control unit recognizes a swipe operation.

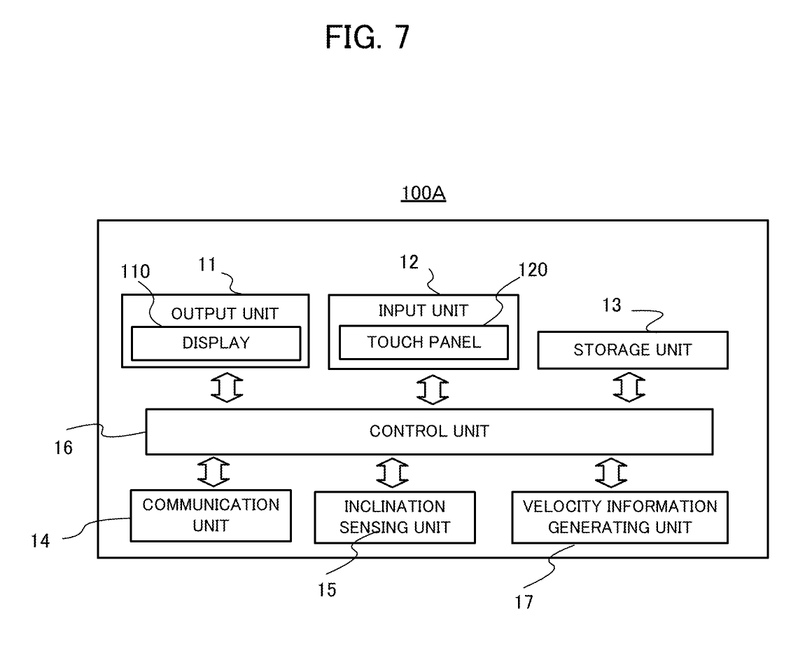

FIG. 7 illustrates a schematic configuration of the terminal device according to the second embodiment.

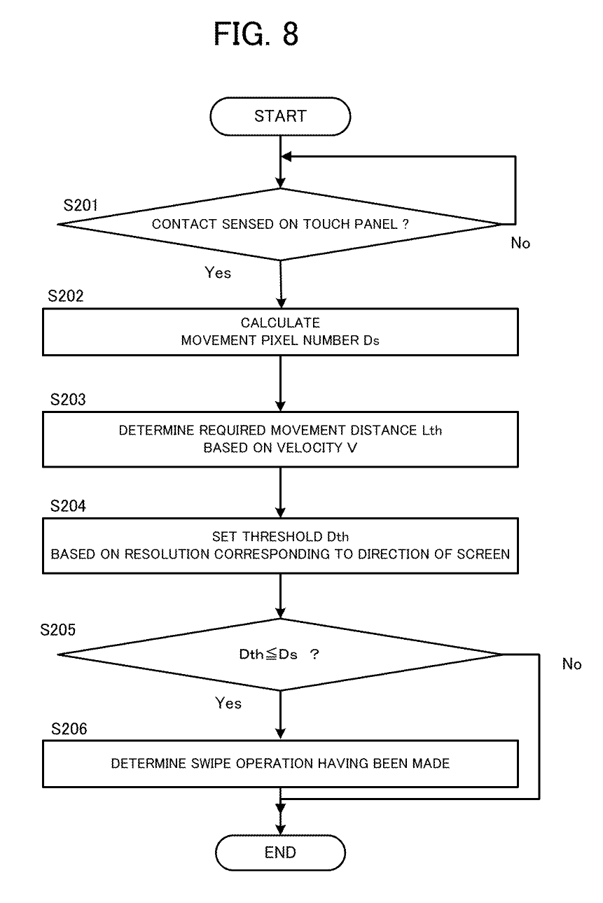

FIG. 8 is an example of a flowchart indicating a determination method regarding the validity of a swipe operation according to the second embodiment.

### DETAILED DESCRIPTION OF THE PREFERRED EMBODIMENTS

According to a preferable embodiment of the present invention, there is provided an information processing device configured to determine whether or not a swipe operation from a user on a touch panel is performed, including: an acquisition unit configured to acquire information on an inherent resolution of the information processing device; and a setting unit configured to set a threshold value corresponding to a movement distance to be determined that the swipe operation is valid, wherein the setting unit sets the threshold value based on the information on the resolution acquired by the acquisition unit.

The above information processing device determines whether or not a swipe operation from a user on a touch panel is performed, and includes an acquisition unit and a setting unit. The acquisition unit acquires information on an inherent resolution of the information processing device. The setting unit sets a threshold value corresponding to a movement distance to be determine that the swipe operation is valid. In this case, the setting unit sets the threshold value based on the information on the resolution acquired by the acquisition unit. By taking the resolution into consideration in this way, preferably, the information processing device can determine the validity of the swipe operation based on a physical movement distance of the swipe on the touch panel.

In a mode of the information processing device, the acquisition unit acquires the information on the resolution with respect to each of a vertical and a horizontal directions of the information processing device, and the setting unit sets the threshold value based on the information on the resolution in the direction corresponding to either the vertical direction or the horizontal direction where the touch panel is used. In this mode, preferably, the information processing device can determine the validity of the swipe operation based on a physical movement distance of the swipe on the touch panel even if the resolution in the vertical direction is different from the resolution in the horizontal direction.

In another mode of the information processing device, the setting unit sets the threshold value so that the movement distance to be determined that the swipe operation is valid is within a predetermined range regardless of a type of the information processing series and/or whether the touch panel is used in the vertical direction or in the horizontal direction. In this mode, preferably, the information processing device can recognize the swipe operation with the same swipe distance regardless of a type of the information processing device and/or whether the information processing device is used in the vertical direction or in the horizontal direction.

In still another mode of the information processing device, the acquisition unit acquires information on a physical size of a screen and a pixel number thereof as the information on the resolution. According to this mode, preferably, the information processing device can calculate the resolution.

According to another preferable embodiment of the present invention, there is provided an information processing device configured to move along with a moving body and to determine whether or not a swipe operation from a user on a teach panel is performed, including: a first acquisition unit configured to acquire information on an inherent resolution of the information processing device; a second acquisition unit configured to acquire information on a running speed of the moving body; and a setting unit configured to set a threshold value corresponding to a movement distance to be determined that the swipe operation is valid, wherein the setting unit determines the movement distance to be determined that the swipe operation is valid based on the information on the running speed while setting the threshold value based on the information on the resolution acquired by the first acquisition unit.

The above-mentioned information, processing device moves along with a moving body and to determine whether or not a swipe operation from a user on a touch panel is performed. The information processing device includes a first acquisition unit, a second acquisition unit and a setting unit. The first acquisition unit acquires information on an inherent resolution of the information processing device. The second acquisition unit acquires information on a running speed of the moving body. The setting unit sets a threshold value corresponding to a movement distance to be determined that the swipe operation is valid. In this case, the setting unit determines the movement distance to be determined that the swipe operation is valid based on the information on the running speed while setting the threshold value based on the information on the resolution acquired by the first acquisition unit. According to this configuration, preferably, the information processing device can determine the validity of the swipe operation based on a physical movement distance of the swipe on the touch panel. In addition the information processing device can properly set the movement distance to be determined that the swipe operation is valid based on the running speed of the moving body.

In a mode of the information processing device, the setting unit determines the movement distance to be determined that the swipe operation as valid so that the higher the running speed is, the shorter the movement distance to be determined that the swipe operation is valid becomes. According to this mode, it is possible to shorten the operation time necessary for the swipe operation at the time of a high-speed movement thereby to improve the security and the operability.

According to still another preferable embodiment of the present invention, there is provided an information processing device configured to determine whether or not a swipe operation from a user on a touch panel is performed, including: an acquisition unit configured to acquire information on an inherent resolution of the information processing device; a pixel number calculation unit configured to calculate a pixel number corresponding to a movement amount of a contact area on the touch panel; a movement distance calculation unit configured to calculate a physical movement distance of the contact area from the pixel number based on the information on the resolution acquired by the acquisition unit; and a determination unit configured to determine that the swipe operation is performed when the movement distance is equal to or larger than a predetermined threshold value. Even in this mode, preferably, the information processing device can determine the validity of the swipe operation based on a physical movement distance of the swipe on the touch panel.

According to still another preferable embodiment of the present invention, there is provided a control method executed by an information processing device which determines whether or not a swipe operation from a user on a touch panel is performed, including: an acquisition process for acquiring information on an inherent, resolution of the information processing device; and a setting process for setting a threshold value corresponding so a movement distance to be determined that the swipe operation is valid, wherein in the setting process, the threshold value is set based on the information on the resolution acquired in the acquisition process. By executing the control method, preferably, the information processing device can determine the validity of the swipe operation based on a physical movement distance of the swipe on the touch panel.

According to still another preferable embodiment of the present invention there is provided a program executed by an information processing device which determines whether or not a swipe operation from a user on a touch panel is performed, making the computer function as: an acquisition unit configured to acquire information on an inherent resolution of the information processing device; and a setting unit configured to set a threshold value corresponding to a movement distance to be determined that the swipe operation is valid, wherein the setting unit sets the threshold value based on the information on the resolution acquired by the acquisition unit. By executing the program, preferably, the information processing device can determine the validity of the swipe operation based an a physical movement distance of the swipe on the touch panel. In a preferred example, the above program is stored in a recording medium.

### EMBODIMENTS

Preferred first and second embodiments of the present invention will be explained hereinafter with reference to the drawings.

### First Embodiment

FIG. 1 illustrates a front view of a terminal device 100 to which the information processing device according to the present invention is applied. The terminal device 100 is a portable terminal which the user can carry, and has a display 110 overlapped with a touch panel 120. The terminal device 100 determines whether or set as operation detected by the touch panel 100 is a swipe operation (i.e., an operation of sliding a pointer such as a finger and a stylus in contact with the display 110).

Hereinafter, the direction of the display 110 used longitudinally as illustrated in FIG. 1 is referred to as “longitudinal direction”, and the direction of the display 110 used laterally is referred to as “lateral direction”. In the following explanation, the swipe operation is performed in either the left or the right direction (left direction in case of FIG. 1) on the display screen.

FIG. 2 illustrates a schematic configuration of the terminal device 100. As illustrated in FIG. 2, the terminal device 100 includes an output unit 11, an input unit 12, a storage unit 13, a communication unit 14, an inclination sensing unit 15, and a control unit 16. Each component of the terminal device 100 is connected to each other via a bus line which is not shown, and capable of exchanging necessary information among them.

The output unit 11 includes the display 110 and an speaker which is not shown, and outputs information for responding to an operation from the user of the terminal device 100 under the control of the control unit 16.

The input unit 12 includes the touch panel 120 and functions as an interface for accepting an input of information or necessary commands through the operation from the user to the terminal device 100. In addition to the touch panel 120, the input unit may also include a key, a switch, a button, anchor a voice input device for inputting various commands and data.

The storage unit 13 stores programs for controlling the terminal device 100 and information necessary for the performance of the terminal device 100. In this embodiment, the storage unit 13 stores information on the resolution with respect to each of the longitudinal and the short (lateral) directions of the display 110. The term “resolution” herein indicates the pixel density of the display 110 whose unit as dpi (Dots Per Inch) for example.

The communication unit 14 exchanges data with other units in accordance with a predetermined communication protocol. For example, under the control of the control unit 16, the communication unit 14 receives screen information used for displaying on the display 110 from a server device via a communication network such as the Internet.

The inclination sensing unit 15 is an acceleration sensor or a gyroscope for example, and senses the inclination (tilt) of the terminal device 100. The inclination sensing unit 15 sends a generated detection signal to the control unit 16.

The control unit 16 includes a CPU (Central Processing unit), a ROC (Read Only Memory), and a RAM (Random Access Memory) which are not shown, and executes various kinds of controls of each component in the terminal device 100. For example, the control unit 10 recognizes the direction of the display 110 based on the detection signal sent from the inclination sensing unit 15. Then, the control unit 16 changes the direction of the display screen image so that it is consistent with the recognized direction of the display 110. On the basis of the detection signal of the touch panel 120, the control unit 16 recognizes the pixel number corresponding to the movement amount of the pointer shifted in contact with the panel thereby to determine whether or not the swipe operation is performed. The control unit 16 is an example of “the acquisition unit”, “the first acquisition unit” and “the setting unit” according to the present invention.

Hereinafter, the term “movement pixel number Ds” indicates the pixel number corresponding to the movement amount of the contact area on the touch panel 120, and the term “movement distance Ls” indicates the physical movement distance (e.g., whose unit is inch) of the contact area on the touch panel 120.

[Determination Method Regarding Validity of Swipe Operation]

Next, a description will be given of the determination method regarding tone validity of too swipe operation according to the first embodiment. In summary, the control unit 16 determines that the swipe operation is conducted in a case that the movement pixel number Ds is equal to or larger than a predetermined threshold value (hereinafter referred to as “threshold value Dth”). In this case, the control unit 16 sets the threshold value Dth so that true movement distance is (hereinafter referred to as “required movement distance Lth”) to be determined that the swipe operation is valid does not depend on the direction and the size of the display 110.

Here, a detail description mill be given of the method for setting the threshold value Dth. The control unit 16 recognizes the direction of the screen based on the output of the inclination sensing unit 15 thereby to set the threshold value Dth based on the resolution corresponding to the recognized direction of the screen. Concretely, the control unit 16 sets the threshold value Dth to a value (i.e., pixel number) acquired by multiplying the required movement distance Lth by the resolution corresponding to the recognized direction of the screen. The term “resolution corresponding to the recognized direction of the screen” herein indicates the resolution of the display 110 along the direction of the swipe operation. In the case that the display 110 is used longitudinally, it indicates the resolution of the display 110 in the short direction, and in the case that the display 110 is used laterally, it indicates the resolution of the display 110 in the longitudinal direction.

Next, a description will be given of the reunited movement distance Lth with reference to FIGS. 3A to 3C. FIG. 3A illustrates the width of the required movement distance Lth in a case that the display 110 is used longitudinally, and FIG. 3B illustrates the width of the required movement distance Lth in a case that the display 110 is used laterally. FIG. 3C indicates the width of the required movement distance Lth of the terminal device 100x with the display 110x larger than the display of the terminal device 100.

As illustrated in FIGS. 3A and 3B, in either case that the display 110 is used in the longitudinal direction or in the lateral direction, each required movement distance Lth is set so be the same width. In addition, as illustrated in FIGS. 3A and 3C, each required movement distance Lth is set to be the same width regardless of the difference of the sites of the displays 110 and 110x.

In this way, the control unit 16 sets the threshold value Dth based on the required movement distance Lth that is a fixed value regardless of the site and the direction of the display 110, and determines that the swipe operation is performed when the movement pixel number Ds is equal to or larger than the threshold value Dth. It is noted that the required movement distance Lth is set to a proper value based on experiments for example and stored on the storage unit 13. Accordingly, regardless of the size or the direction of the display 110, the control unit 16 can properly recognize that the swipe operation is performed in the case that the movement distance Ls is equal to or longer than the required movement distance Lth.

FIG. 4 is an example of a flowchart indicating the determination method regarding the validity or the swipe operation according to the first embodiment. The control unit 16 repeatedly executes the process of the flowchart indicated by FIG. 4.

First, the control unit 16 determines whether or not any contact on the touch panel 120 has been sensed (step S101). Then, when the control unit 16 has sensed a contact to the truth panel 120 (step S101; Yes), the control unit 16 proceeds with the process at step S102. In contrast, when the control unit 16 has not sensed any contact to the touch panel 120 yet (step S101; No), the control unit 16 continues to monitor whether or not any contact on the touch panel 120 has been sensed at step S101.

Next, at step S102, the control unit 16 calculates the movement pixel number Ds corresponding to the distance by which the recognized contact area has shifted (step S102). For example, she control unit 16 sets the movement pixel number Ds to the pixel difference in the horizontal (main scanning) direction between the pixel position nearest so the central position of the contact area firstly sensed by the touch panel 120 and the pixel position nearest to the central position of the contact area lastly sensed by the touch panel 120.

Next, the control unit 16 sets the threshold value Dth based on the resolution corresponding to the direction of the screen (step S103). First, the control unit 16 recognizes the direction of the screen based on the output of the inclination sensing unit 15, and acquires from the storage unit 13 the information on the resolution corresponding to the recognized direction of the screen and information on the required movement distance Lth. Then, the control unit 16 sets the threshold value Dth by multiplying the required movement distance Lth by the above-mentioned resolution.

Next, the control unit 16 determines whether or not the movement pixel number Ds is equal to or larger than the threshold value Dth (step S104). Then, when the movement pixel number Ds is equal to or larger than the threshold value Dth (step S104; Yes), the control unit 16 determines that the swipe operation is performed (step S105). In contrast, when the swipe operation is smaller than the threshold value Dth (step S104; No), the control unit 16 determines that the swipe operation is not performed. For example, in this case, the control unit 16 determines that merely a touch operation on the display 110 is performed. Then, the control unit 16 ends the process of the flowchart.

[Concrete Example of Swipe Operation]

Next, a description will be given of concrete examples of the process in response to the swipe operation with reference to FIGS. 4 to 6B. Hereinafter, a description will be given of the process for accepting a voice input after it recognize the swipe operation whose start point is a position within a predetermined range.

FIG. 5 illustrates the display 110 which displays a map including a present position mark 21 indicating the present position. In FIG. 5, the voice input mark 22 indicating the capability of a voice input is displayed at the right edge of the display 110. In this case, it is assumed that the control unit 16 starts to accept a voice input when the control unit 16 recognizes the swipe operation toward the left direction whose start point is a position within the dashed frame 23 in FIG. 5.

In the case of FIG. 5, the user swipes (flicks) the pointer toward the left direction by the movement distance Ls from a predetermined position in the dashed frame 23 including the position of the voice input mark 22. In this case, the control unit 16 calculates the movement pixel number Ds based on the movement of the contact area sensed by the touch panel 120 (see step S101 and step S102 in FIG. 4). Additionally, the control unit 16 recognizes the direction of the screen based on the output of the inclination sensing unit 15 to calculate the threshold value Dth by multiplying the required movement distance Lth by the resolution corresponding to the recognized direction of the screen (see step S103 in FIG. 4). In this case, the control unit 16 recognizes the swipe operation is performed since it determines that the movement pixel number Ds is equal to or larger than the threshold value Dth (step S105 in FIG. 4).

FIGS. 6A and 6B illustrate the screen transition of the display 110 after the control unit 16 recognizes she swipe operation whose start point is a position existing within the dashed frame 23 in FIG. 3.

As illustrated in FIG. 6A, when the control unit 16 recognizes the swipe operation toward the left side whose start point is a position existing within the dashed frame 23 in FIG. 5, the control unit 16 slides the animation image 26 so that the image gradually covers the whole map from the right edge of the display 110 to the left edge of the display 110. Preferably, in this case, the control unit 16 may determine the sliding speed of the animation image 26 so that the higher the swiping speed is, the higher the sliding speed of the animation image 26 becomes. In this case, the control unit 16 recognizes the time length of the swipe operation and calculates the swipe speed by dividing the previously-recognized movement distance Ls by the time length.

After the animation image 26 has been displayed on the whole display 110, the control unit 16 displays on the display 110 the message “PLEASE SPEAK” and the icon indicating a microphone thereby to urge the user to input a voice and to accept the voice input. For example, in a case that the user inputs the voice “CONVENIENCE STORES AROUND HERE”, the control unit 16 searches for convenience stores in the vicinity of the present position and displays the information thereof on the display 110. In another case that the user inputs the voice “TRAFFIC JAM INFORMATION”, the control unit 16 receives the traffic jam information around the present position from a predetermined server via the communication unit 14 and displays it on the display 110.

As explained above, the terminal device 100 according to the first embodiment recognizes the swipe operation on the touch panel 120 performed by the user. The control unit 16 reads out the information on the resolution from the storage unit 13. Next, the control unit 16 sets the threshold value Dth in accordance with the required movement distance Lth to be determined that the swipe operation is valid. Concretely, the control unit 16 calculates the threshold value Dth by multiplying the required movement distance Lth by the resolution read out from the storage unit 13. Thereby, preferably, the terminal device 100 can recognize the swipe operation based on the physical operation amount indicating the movement amount in a state that the user touches the touch panel 120.

### Second Embodiment

The terminal device 100A according to the second embodiment is a stationary navigation device or a portable navigation device which moves along with a moving body such as a vehicle, and preferably accepts the swipe operation by changing the required movement distance Lth in accordance with the velocity (referred to as “velocity V”) of the moving body.

FIG. 7 illustrates a schematic configuration of the terminal device 100A according to the second embodiment. The terminal device 100A according to the second embodiment is different from the terminal device 100 according to the first embodiment in that the terminal device 100A is equipped with the velocity information generating unit 17. Other components are provided with the same reference numbers and the explanation thereof will be omitted as appropriate.

The velocity information generating unit 17 generates information on the velocity of the moving body reeving along with the terminal device 100A and sends it to the control unit 16. For example, in a case that the moving object is a vehicle, the velocity information generating unit 17 measures vehicle speed pulses indicated by pulse signals generated with the wheel rotation of the vehicle and sends information on the treasured vehicle speed pulses so the control unit 16. In this case, the control unit 16 calculates the velocity V based on the received information on the vehicle speed pulses. In another example, the velocity information generating unit 17 is a GPS receiver which generates information on the present position, and sends the information on the present position to the control unit 16. In this case, the control unit 10 calculates the velocity V based on the time variation of the present position. A pair of the velocity information generating unit 17 and the control unit 16 is an example of “the second acquisition unit” according to the present invention.

Here, a description will be given of the method for setting the required movement distance Lth based on the velocity V. Preferably, the control unit 16 sets the required movement distance Lth so that the higher the velocity V is, the smaller the required movement distance Lth becomes. For example, in a case that the velocity V is equal to or higher than a predetermined velocity (e.g., 60 km/h), the control unit 16 determines that the longer the operation time is, the higher the risk becomes, and therefore decreases the required movement distance Lth by a predetermined rate or a predetermined distance. Thereby, the control unit 16 can shorten the operation time needed for the swipe operation as necessary to improve the safety. Instead of this example, or in addition to this example, in a case that the velocity V is equal to or smaller than a predetermined velocity (e.g., 20 km/h), the control unit 16 increases the required movement distance Lth by a predetermined rate or a predetermined distance on the assumption that the running road is a dirt road such as an earth road. Thereby, preferably, the control unit 16 can suppress falsely recognizing the touch operation as the swipe operation due to the vibration of the vehicle. In another example, the control unit 16 may set the required movement distance Lth based on the velocity V by referring to a map or an equation indicating each appropriate required movement distance Lth corresponding to each velocity V. For example, the above-mentioned map or the equation is prepared through experimental trials in advance, and stored beforehand on the storage unit 13.

FIG. 8 is an example of a flowchart indicating the determination method regarding the validity of the swipe operation according to the second embodiment. The control unit 16 repeatedly executes the process of the flowchart in FIG. 3.

At the time of sensing the contact on the touch panel 120 (step S201; Yes), the control unit 16 calculates the movement pixel number Ds (step S202). Then, the control unit 16 determines the required movement distance Ltn based on the velocity V (step S203). For example, at the time of a high speed movement, the control unit 16 shortens the required movement distance Lth in order to shorten the operation time. In contrast, at the time of a low-speed movement, the control unit 16 increases the required movement distance Lth in order to suppress the false recognition due to the vehicle vibration.

Thereafter, the control unit 16 executes the same process as step S103 to step S105 in FIG. 4. Concretely, the control unit 16 sets the threshold value Dth based on the resolution corresponding to the direction of the screen (step S204), and in the case that the movement pixel number Ds is equal to or larger than the threshold value Dth (step S205; Yes), the control unit 16 determines that the swipe operation is performed (step S206).

In this way, the control unit 16 can properly accept the snipe operation even in motion. In contrast, in such an input manner that the user touches an icon on the display 110, it could be difficult for the user to input information because gazing at the display 110 in motion is difficult. Thus, for example, the control unit 10 purposely increases an opportunity of an input by the swipe operation instead of an input by the touch operation to improve the operability.

As explained above, the terminal device 100A according to the second embodiment recognizes the swipe operation from the user on the touch panel 120. The control unit 16 reads out the information on the resolution from the storage unit 13. The control unit 16 recognizes the velocity V based on the information acquired from the velocity information generating unit 17. The control unit 16 sets the threshold value Dth in accordance with the required movement distance Lth that is the movement distance Ls to be determined that the swipe operation is valid. In this case, after determining the required movement distance Lth based on the velocity V, the control unit 16 calculates the threshold value Dth by multiplying the required movement distance Lth by the resolution read out from the storage unit 13. Thereby, on the basis of the velocity V, the terminal device 100A can properly set the operation amount for validly accepting the swipe operation.

### MODIFICATION

Hereinafter, a description will be given of preferred modifications of the first and the second embodiments. Each modification can be applied to each of the above-mentioned embodiment's in combination.

### First Modification

The storage unit 13 stores information on the resolution in the longitudinal ann the snort directions of the display 110. However, the configuration to which the present invention can be applied is not limited to the configuration.

Instead, for example, the storage unit 13 stores information on the model name of the terminal device 100 in advance, and at the time of installing an application for performing tne process according to the embodiments, tne storage unit 13 stores corresponding table between each model name and the resolution, corresponding thereto. In this case, on the basis of the model name stored on the storage unit 13, the control unit 16 acquires the information on the corresponding resolution with reference to the corresponding table.

In another example, instead of the information on the resolution, the storage unit 15 may store information on the physical lengths of the display 110 in the longitudinal and the short directions and information on the pixel numbers of the display 110 in the longitudinal and the snort directions. In this case, the control, unit 16 calculates tne resolution in each direction by dividing the pixel number by the length of the display 110 with respect to each of the longitudinal and the short directions.

### Second Modification

Regarding the first embodiment, the control unit 16 may recognize the finger used for the operation on the touch panel 120 and determine the required movement distance Lth based on the recognized finger.

For example, in a case that the control unit 16 senses the contact on the touch panel 120 by the thumb of the right hand, true control unit 16 determines that the operation is performed by use of the hand holding the terminal device 100. In this case, the control unit 16 determines that the movement distance Ls tends to be short, and therefore it shortens the required movement distance Lth by a predetermined rate or a predetermined distance. In contrast, in a case that the control unit 16 senses the contact to the touch panel 120 by any finger of the left hand, the control unit 16 determines that the operation is performed by use of the hand which does not hold the terminal device 100. In this case, the control unit 16 enlarges the required movement distance Lth by a predetermined rate or a predetermined distance in order to prevent the false recognition for sure.

A description will be given of a concrete example of the method for recognizing the finger touching the touch panel 120. For example, the control unit 16 stores on the storage unit 13 the feature amount concerning the shape and/or the size of the contact area of each finger of each hand which is in contact with the touch panel 120. Then, when the touch panel 120 senses a contact, the control unit 16 calculates the above-mentioned feature amount through a predetermined image processing with respect to the detected contact area. Then, the control unit 16 compares the calculated feature amount to the feature amount of each finger stcred in advance. Thereby, the control unit 16 recognizes the finger corresponding to the stored feature amount nearest to the calculated feature amount as the finger touching the touch panel 120.

### Third Modification

According to FIG. 4 or FIG. 8, the control unit 16 determines that the swipe operation is performed in the case that the movement pixel number Ds is equal to or larger than the threshold value Dth. Instead, the control unit 16 may determine that the swipe operation is performed in a case that the movement distance Ls calculated by the control unit 16 is equal to or longer than the required movement distance Lth. In this case, the control unit 16 calculates the movement distance Ls by dividing the movement pixel number Ds by the resolution corresponding to the direction of the screen. Even in this case, as with the first and the second embodiments, the control unit 16 can recognize the swipe operation with the seme operation amount regardless of the size and/or the direction of the display 110. In this case, the control unit 16 as an example of “the movement distance calculation unit” and “the determining unit”.

### BRIEF DESCRIPTION OF THE REFERENCE NUMBER

11 Output unit
12 Input unit
13 Storage unit
14 Communication unit
15 Inclination sensing unit
16 Control unit
17 Velocity information generating unit
100, 100x and 100A Terminal device
110 Display
120 Touch panel

1. An information processing device configured to determine whether or not a swipe operation from a user on a touch panel is performed, comprising:
a first acquisition unit configured to acquire information on an inherent resolution of the information processing device; and
a setting unit configured to set a threshold value corresponding to a movement distance to be determined that the swipe operation is valid,
wherein the setting unit sets the threshold value based on the information on the resolution acquired by the first acquisition unit.

2. The information processing device according to claim 1,
wherein the first acquisition unit acquires the information on the resolution with respect to each of a vertical and a horizontal directions of the information processing device, and
wherein the setting unit sets the threshold value based on the information on the resolution in the direction corresponding to either the vertical direction or the horizontal direction where the touch panel is used.

3. The information processing device according to claim 1,
wherein the setting unit sets the threshold value so that the movement distance to be determined that the swipe operation is valid is within a predetermined range regardless of a type of the information processing device and/or whether the touch panel is used in the vertical direction or in the horizontal direction.

4. The information processing device according to claim 1,
wherein the first acquisition unit acquires information on a physical size of a screen and a pixel number thereof as the information on the resolution.

5. The information processing device according to claim 1, further comprising
a second acquisition unit configured to acquire information on a running speed of a moving body on which the information processing device is mounted,
wherein the setting unit determines the movement distance to be determined that the swipe operation is valid based on the information on the running speed while setting the threshold value based on the information on the resolution acquired by the first acquisition unit.

6. The information processing device according to claim 5,
wherein the setting unit determines the movement distance to be determined that the swipe operation is valid so that the higher the running speed is, the shorter the movement distance to be determined that the swipe operation is valid becomes.

7. (canceled)

8. A control method executed by an information processing device which determines whether or not a swipe operation from a user on a touch panel is performed, comprising:
a first acquisition process for acquiring information on an inherent resolution of the information processing device; and
a setting process for setting a threshold value corresponding to a movement distance to be determined that the swipe operation is valid,
wherein in the setting process, the threshold value is set based on the information on the resolution acquired in the first acquisition process.

9. (canceled)

10. (canceled)

11. A control method executed by an information processing device which determines whether or not a swipe operation from a user on a touch panel is performed, comprising:
a first acquisition process for acquiring information on an inherent resolution of the information processing device;
a pixel number calculation process for calculating a pixel number corresponding to a movement amount of a contact area on the touch panel;
a movement distance calculation process for calculating a physical movement distance of the contact area from the pixel number based on the information on the resolution acquired by the acquisition unit; and
a determination process for determining that the swipe operation is performed when the movement distance is equal to or larger than a predetermined threshold value.

12. The information processing device according to claim 2, wherein the setting unit sets the threshold value so that the movement distance to be determined that the swipe operation is valid is within a predetermined range regardless of a type of the information processing device and/or whether the touch panel is used in the vertical direction or in the horizontal direction.

13. The information processing device according to claim 2, wherein the first acquisition unit acquires information on a physical size of a screen and a pixel number thereof as the information on the resolution.
